(19) United States
(12) Patent Application Publication
(10) Pub. No.: US 2026/0195089 A1
(43) Pub. Date: Jul. 9, 2026

(54) UNIVERSAL SOUND EVENT DETECTOR USING MULTI-LAYERED CONDITIONING

(71) Applicant: Google LLC, Mountain View, CA (US)

(72) Inventors: Aren Jansen, Mountain View, CA (US); Daniel Patrick Whittlesey Ellis, New York, NY (US)

(21) Appl. No.: 19/131,585

(22) PCT Filed: Dec. 6, 2022
(86) PCT No.: PCT/US2022/051946

§ 371 Date: May 21, 2025

(51) Int. Cl. G06F 3/16

(52) U.S. Cl. CPC G06F 3/16

(57) ABSTRACT

Aspects of the disclosure may involve training a sound event detection model (100, 300) to identify whether a second sound recording includes a sound of a reference clip. For instance, a sound event reference example including a first sound recording and a label indicative of whether the first sound recording includes a sound may be received. A breadth parameter, the breadth parameter being indicative of whether the sound event detection model detects a specific sound event, a class of sounds, or both may be received. The sound event reference example may be augmented to generate a test clip. The sound event detection model may be trained using the sound event reference example, the test clip, the breadth parameter, and the label. The sound event detection model includes a neural network (104, 304a, 304b) including reference encoder (106, 306a, 306b) and a sound event detector (108, 308a, 308b). The training may involve simultaneously training the neural networks.

### BACKGROUND

Sound models capable of personalized sound sensing generally depend on a system trained to collocate different reference recordings of the same target sound event with a detected target sound event. This is accomplished by isolating the target event within a sound recording by, for example, removing background noise. In more complex sound environments, such as systems with increased intrinsic and extrinsic variability, e.g., increased background noise, variability in the target event, or other sounds of a similar class to the target sound, isolation of a target sounds may be more challenging. The reference recordings have an increased burden of representing the target event.

### BRIEF SUMMARY

Aspects of this disclosure provide a computer-implemented method that includes receiving, by one or more processors, a sound event reference example including a first sound recording and a label indicative of whether the first sound recording includes a first sound; receiving, by the one or more processors, a breadth parameter, the breadth parameter being indicative of whether a sound event detection model detects (1) a specific sound event, (2) a class of sounds, (3) or both; augmenting, by the one or more processors, the sound event reference example to generate a test clip; and training, by the one or more processors, the sound event detection model using the sound event reference example, the test clip, the breadth parameter, and the label, wherein the sound event detection model includes a neural network; wherein the neural network includes (1) a reference encoder and (2) a sound event detector, in which the training involves simultaneously training the reference encoder and the sound event detector, the sound event detection model being configured to output a label identifying whether a second sound recording includes a second sound of a reference clip.

In one example, the method further includes receiving the second sound recording, the second sound recording containing a sampling of sounds from an environment of a user; and determining whether the second sound recording includes the sound of the reference clip using the trained sound event detection model.

In another example, determining whether the second sound of the reference clip is present in the second sound recording using the trained sound event detection model includes determining a probability distribution indicative of whether (1) a specific sound event, (2) a class of sounds, (3) or both are present in the second sound recording; and outputting a binary classifier indicative of whether (1) a specific sound event, (2) a class of sounds, (3) or both are present in the second sound recording based on the probability distribution.

In one example, the neural network employs feature-wise linear modulation (FiLM). In another example, the neural network is a convolutional neural network (CNN). The neural network may employ a Transformer neural network architecture.

Augmenting the sound event reference example may include adding background noise to the sound event reference example. Alternatively or additionally, augmenting the sound event reference example includes changing a volume of the sound event reference example. Alternatively or additionally, augmenting the sound event reference example includes adding reverberation to the sound event reference example. The first sound recording and the second sound recording may be from an environment of a user.

Another aspect of the disclosure provides a computer-implemented method that includes receiving, by one or more processors, a first sound recording, the first sound recording containing a sampling of sounds from an environment of a user; receiving, by the one or more processors, a breadth parameter, the breadth parameter being indicative of whether a sound event detection model detects (1) a specific sound event, (2) a class of sounds, (3) or both, wherein the sound event detection model includes a first neural network having a first reference encoder and a first sound event detector; and determining, by the one or more processors, whether the first sound recording includes a sound of a reference clip using a sound event detection model by determining a probability distribution indicative of whether (1) a specific sound event, (2) a class of sounds, (3) or both are present in the first sound recording, the sound event detection model being configured to output a label identifying whether the first sound recording includes the sound of the reference clip.

In one example, determining whether the sound of the reference clip is present in the first sound recording using the sound event detection model further includes outputting a binary classifier indicative of whether (1) a specific sound event, (2) a class of sounds, (3) or both are present in the first sound recording based on the probability distribution. Alternatively or additionally, the first sound recording, the breadth parameter, and the reference clip are input into the first neural network. Alternatively or additionally, determining whether the sound of the reference clip is present in the first sound recording includes inputting the reference clip and the breadth parameter into the first reference encoder in order to generate one or more conditioning elements.

In a further example, the one or more conditioning elements includes at least one of (1) a conditioned activation function based on the reference clip and (2) an encoding of the reference clip. In another example, determining whether the sound of the reference clip is present in the first sound recording includes inputting the one or more conditioning elements into the first sound event detector in order to determine the probability distribution.

In one example the first neural network employs feature-wise linear modulation (FiLM) and the first neural network is a convolutional neural network (CNN). the first neural network may employ a Transformer neural network architecture. In a further example, the reference clip includes a sampling of sounds from the environment of the user.

The method may further include receiving a second sound recording. Here, the second sound recording contains a sampling of sounds from the environment of the user. Determining a second sound of a second reference clip is present in the second sound recording involves using the sound event detection model, in which the sound event detection model is configured to output a label identifying whether a second sound of a second reference clip is present in the second sound recording. In this case, the sound event detection model may include a second neural network that further includes a second reference encoder and a second sound event detector.

### BRIEF DESCRIPTION OF THE DRAWINGS

FIG. 1 illustrates an example sound event detection model 100 in accordance with aspects of the technology.

FIG. 2 illustrates an example method in accordance with aspects of the technology.

FIG. 3 illustrates an example sound event detection model 300 in accordance with aspects of the technology.

FIG. 4 illustrates an example method in accordance with aspects of the technology.

FIG. 5 illustrates a Transformer neural network architecture that may be employed in accordance with aspects of the technology.

FIGS. 6A-6B illustrate a system for use with aspects of the technology.

### DETAILED DESCRIPTION

The present technology will now be described with respect to the following exemplary systems and methods. Reference numbers in common between the figures depicted and described below are meant to identify the same features.

### Overview

The technology relates to systems implementing sound event detection models capable of personalized sound sensing. An approach may be used in which the model applies multi-layer conditioning to enable the system to detect both classes of sounds and specific sound instances within a complex sound environment. A sound event detection model for personalized sound sensing may contain a neural network. The neural network may include a reference encoder and a sound event detector, where the reference encoder and sound event detector may be neural networks.

The sound event detection model may be configured to receive one or more inputs. In one instance, the one or more inputs may include one or more sound event reference examples and a sound recording. The one or more sound event reference examples may include one or more sound events to be detected, such as an example sound recording containing a specific sound event to be detected or a sound event from a class of sounds to be detected.

The one or more inputs may also include a breadth parameter. The breadth parameter may be received from the user or be pre-determined. The breadth parameter may indicate whether the one or more sound events to be detected by the sound event detection model includes a specific sound event, a sound event from a class of sounds, or both.

The reference encoder may receive inputs including the one or more reference examples of the one or more inputs. In some implementations, these received inputs may additionally include the breadth parameter of the one or more inputs. The reference encoder may output one or more conditioning elements.

The sound event detector may receive inputs including the sound recording and the conditioning elements output from the reference encoder. The one or more conditioning elements from the reference encoder may include, for example, a conditioned activation function based on the one or more sound event reference examples. Additionally or alternatively, the one or more conditioning elements may include an encoding of a reference clip or a single pooled encoding vector for the reference clip.

The sound event detector may output a score indicative of whether the sound recording contains one or more sound events, such as a specific sound or a sound event from a class of sounds. In some instances, the score may be a real-valued score indicative of whether the sound recording includes the one or more sound events. The real-valued score may be a probability distribution. The score may be used to produce a binary classification for a sound recording.

In this regard, a sound recording containing a sampling of sounds from the environment of the user may be received by the sound event detection model. Whether the one or more sound events are present in the sound recording using the sound event detection model may be determined. The sound event detector may then output a score indicative of whether the sound recording contains a specific sound event and/or a sound event from a class of sounds. In some instances, the sound event detector may also utilize output from the reference encoder identifying one or more conditioning elements determined according to a desired breadth parameter as described above As such, based on the desired breadth parameter, determining if one or more sound events are present in the sound recording may include determining an output indicative of if (1) a specific sound event of the one or more sound events, (2) a class of sounds of the one or more sound events, (3) or both are present in the sound recording.

The sound event detection model may be trained to determine whether one or more sound events are present in an environment of a user utilizing the sound event detection model. The one or more sound events may be a specific sound event to be detected or a sound event from a class of sounds to be detected. A sound event reference example including a first sound recording and a label indicative of whether the first sound recording includes a sound may be received. A breadth parameter may be received. This breadth parameter is indicative of if the sound event detection model detects (1) a specific sound event of the one or more sound events, (2) a class of sounds of the one or more sound events, (3) or both. The sound event reference example may be augmented based on the test clip and the breadth parameter. The sound event detection model may be trained using the one or more augmented sound event reference examples, the test clip, the breadth parameter, and the label. Each test clip, sound event reference example, and the breadth parameter may thus be used as training inputs to train the sound event detection model. In addition, the labels indicative of whether the sound event reference example is present in the sound event reference example of the plurality of training examples during the training phase as training outputs. The training may involve using the training inputs and outputs to tune parameter values of the various neural networks of the sound event detection model.

The features and methodology described herein may provide a model configured to perform personalized sound sensing in complex sound environments. The architecture allows for detection of sound events (e.g., specific sound events, a sound event from a class of sounds) in environments with increased intrinsic and extrinsic variability. Moreover, detection may be accomplished without isolating a target sound event. Furthermore, the architecture described herein may be utilized in both resource constrained and less-resource constrained systems. For example, a Transformer neural network architecture as described herein may be particularly advantageous in a less-resource constrained system (e.g., system with less-limited processing power); whereas a Feature-wise Linear Modulation (FiLM) conditioning approach described herein may be particularly advantageous in a resource constrained system (e.g., systems with limited processing power),

### Detecting Specific Sound Events and Classes of Sounds

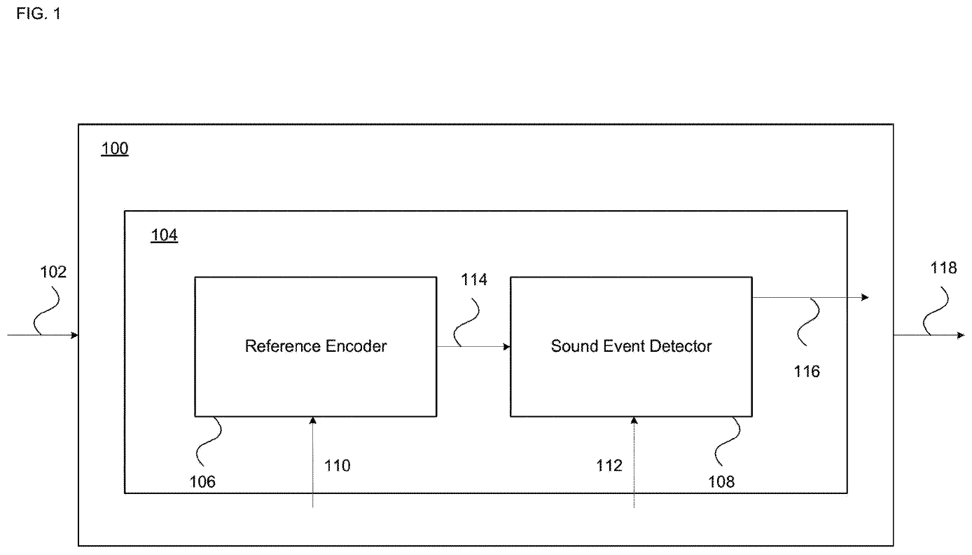

The sound event detection model for personalized sound sensing may contain a neural network. The neural network may include a reference encoder and a sound event detector, where the reference encoder and sound event detector may be neural networks. In one example, sound event detection model 100, as shown in FIG. 1, may be configured to receive one or more inputs 102. In one instance, the one or more inputs 102 may include one or more sound event reference examples and a sound recording. The one or more sound event reference examples may include one or more sound events to be detected, such as an example sound recording containing a specific sound event to be detected or a sound event from a class of sounds to be detected. In some implementations, the one or more reference examples may include a previous sound recording supplied by a user (e.g., the user's microwave beeping, the user's dog barking, etc.). In this regard, the sound event detection model may be trained to detect sounds of the user (e.g., the user's microwave beeping, the user's dog barking, etc.). The sound recording may be a sampling of sounds from an environment of the user. The sound recording may be collected automatically or based on a request of the user.

In some instances, the one or more inputs 102 may also include a breadth parameter. The breadth parameter may be received from the user or be pre-determined. The breadth parameter may indicate whether the one or more sound events to be detected by the sound event detection model includes a specific sound event, a sound event from a class of sounds, or both. In one example, a breadth parameter may indicate a specific sound event is to be detected. This is an example of narrow breadth. By way of example, detecting a specific sound event could include determining if a sound recording contains beeps from a microwave and not merely any electronic beep from any appliance. In another example, a breadth parameter may indicate a sound event from a class of sounds is to be detected. This is an example of wide breadth. By way of example, detecting a sound event from a class of sounds could include determining if a sound recording contains any electronic beep for any appliance and not determine if a specific beep came from a specific appliance or otherwise.

The sound event detection model 100 may include one or more neural networks 104. Neural networks 104 may further include a reference encoder 106 and a sound event detector 108. The reference encoder 106 and a sound event detector 108 may thus each be additional neural networks.

The reference encoder 106 may receive inputs 110. Inputs 110 may include the one or more reference examples of the one or more inputs 102. In some implementations, inputs 110 may additionally include the breadth parameter of the one or more inputs 102. The reference encoder 106 may output one or more conditioning elements.

The sound event detector 108 may receive inputs 114 and inputs 112. Inputs 112 may include the sound recording of the one or more inputs 102. Inputs 114 may include the one or more conditioning elements output from the reference encoder 106. The one or more conditioning elements from the reference encoder may include, for example, a conditioned activation function based on the one or more sound event reference examples. Additionally or alternatively, the one or more conditioning elements may include an encoding of a reference clip or a single pooled encoding vector for the reference clip. This reference clip may include or be a known recorded example of a sound event or class of sounds to be detected.

The sound event detector 108 may output a score indicative of whether the sound recording contains one or more sound events, such as a specific sound or a sound event from a class of sounds. The score may thus be an output 116 of the one or more neural networks 104. In some instances, the score may be a real-valued score indicative of whether the sound recording includes the one or more sound events. The real-valued score may be a probability distribution. In some instances, the real-valued score may be a conditional probability. In one example, the sound event detector 108 may determine a posterior distribution and output a score indicative of whether the sound recording includes the one or more sound events. In this regard, the score may be a single point of the posterior distribution.

The output 116 may be used by the sound event detection model 100 to produce a binary classification for a sound recording as output 118. For example, by comparing the output 116 to a threshold or thresholding, the sound event detection model 100 may generate a binary value representative of a positive or negative (e.g., yes or no, 0 or 1, 1 or 0, etc.) determination of the presence of the one or more sound events in the sound recording. By way of example, if a threshold is set to a value of 80% and the probability distribution indicates there is greater than or equal to 80% chance that a sound recording contains one or more sound events, the sound event detection model 100 may return a positive indication or rather an indication that the one or more sound events is present in the sound recording. As another example, using the value of 80% for the threshold and if the probability distribution indicates there is less than an 80% chance that a sound recording contains a one or more sound events, the sound event detection model 100 may return a negative indication or rather an indication that the one or more sound events is not present in the sound recording.

In some implementations, the sound event detection model 100 may be configured to produce a plurality of binary classifications for a sound recording as output 118. In this regard the sound event detection model may be configured to produce a binary classification for each timestep of the recording. For example, if a sound recording is 5 seconds and each timestep is 1 second, the sound event detection model 100 may be configured to produce five binary classifications as output 118, indicative of the presence of one or more sound events at each timestep of the sound recording. In this regard, each binary classification may be compared to a threshold to generate a binary value as discussed above.

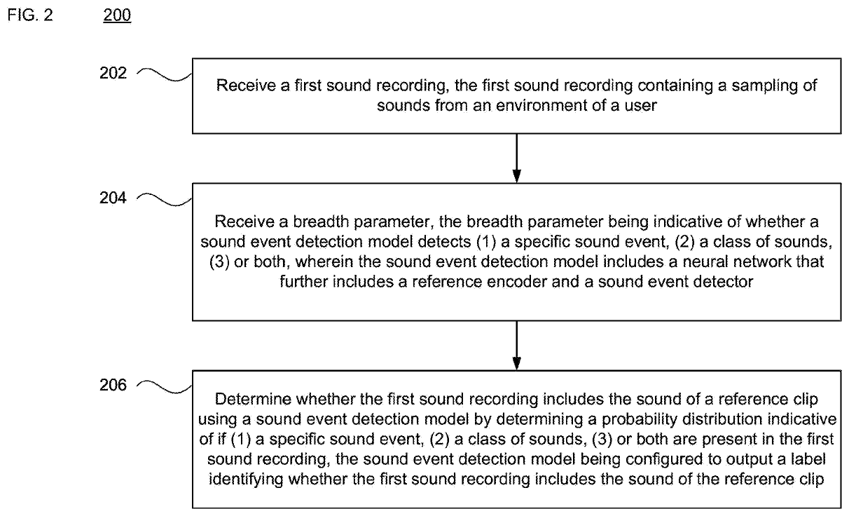

FIG. 2 illustrates an example method 200 of determining if one or more sound events are present in an environment of a user utilizing the sound event detection model 100. The one or more sound events may be a specific sound event and/or a sound event from a class of sounds. As shown in block 202, the method may include receiving a sound recording, the sound recording containing a sampling of sounds from the environment of the user. The sound recording may be included in the one or more inputs 102.

At block 204, a breadth parameter indicative of whether a sound event detection model detects (1) a specific sound event, (2) a class of sounds, (3) or both, wherein the sound event detection model includes a neural network that further includes a reference encoder and a sound event detector is received.

At block 206, whether the first sound recording includes the sound of a reference clip using a sound event detection model by determining a probability distribution indicative of if (1) a specific sound event, (2) a class of sounds, (3) or both are present in the first sound recording is determined. The sound event detection model is configured to output a label identifying whether the first sound recording includes the sound of the reference clip. For example, as described above, the sound recording of the one or more inputs 102 may be input into the sound event detector 108. The sound event detector may then output a score indicative of whether the sound recording contains a specific sound event and/or a sound event from a class of sounds. In some instances, the sound event detector 108 may also utilize output from the reference encoder 106 identifying one or more conditioning elements determined according to a desired breadth parameter as described above As such, based on the desired breadth parameter, determining if one or more sound events are present in the sound recording may include determining an output indicative of if (1) a specific sound event of the one or more sound events, (2) a class of sounds of the one or more sound events, (3) or both are present in the sound recording.

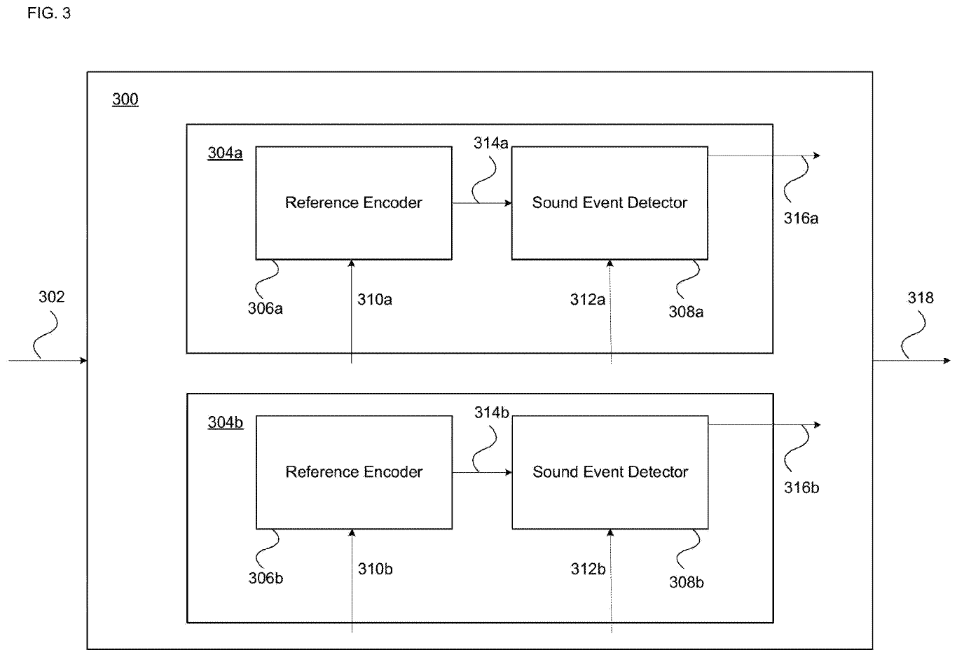

FIG. 3 provides an example of a sound event detection model 300 which may be configured to detect multiple sound events, such as, specific sound events and/or sounds from classes of sounds simultaneously. In this example, the one or more inputs 302 may be configured the same or similar to one or more inputs 102, the one or more neural networks 304a, 304b may be configured the same or similarly to the one or more neural networks 104, the reference encoder 306a, 306b may be configured the same or similarly to the reference encoder 106, the sound event detector 308a, 308b may be configured the same or similarly to the sound event detector 108, and so on. However, while sound event detection model 300 illustrates two neural networks 304a, 304b, a sound event detection model configured to detect multiple sound events simultaneously may include additional neural networks.

In this regard, the sound event detection model 300 may be configured to receive one or more inputs 302 including a plurality of sound event reference examples and a plurality of sound recordings. As with the example of the sound event detection model 100, The one or more sound event reference examples may include one or more sound events to be detected, such as an example sound recording containing a specific sound event to be detected or a sound event from a class of sounds to be detected. In some implementations, the one or more reference examples may include a previous sound recording supplied by a user (e.g., the user's microwave beeping, the user's dog barking, etc.). In this regard, the sound event detection model may be trained to detect sounds of the user (e.g., the user's microwave beeping, the user's dog barking, etc.). The sound recording may be a sampling of sounds from an environment of the user. The sound recording may be collected automatically or based on a request of the user.

Each reference encoder 306a, 306b may receive inputs 310a, 310b. Inputs 310a, 310b may include at least one of the plurality of reference examples. In some implementations, inputs 310a, 310b may additionally include a breadth parameter.

The reference encoders 306a, 306b may each output one or more conditioning elements. The one or more conditioning elements from the reference encoder may include, for example, a conditioned activation function based on the one or more sound event reference examples. Additionally or alternatively, the one or more conditioning elements may include an encoding of a reference clip or a single pooled encoding vector for the reference clip. This reference clip may include or be a known example of a sound event or class of sounds to be detected.

The sound event detectors 308a, 308b may receive inputs 314a, 314b and inputs 312a, 312b. Inputs 312a, 312b may each include at least one of the plurality of sound recordings. Inputs 314a, 314b may include one or more of conditioning elements output from each respective reference encoder 306a, 306b. As described above, the breadth parameter may indicate whether the one or more sound events to be detected by the sound event detection model includes a specific sound event, a sound event from a class of sounds, or both.

Each sound event detector 308a, 308b may output a score indicative of if one or more sound events, such as, a specific sound or a sound event from a class of sounds is contained in the sound recording received by each neural network 304a, 304b. The scores may be an output 316a, 316b of each neural network 304a, 304b. The scores may be real-valued scores indicative of the sound class and/or specific sound contained in each sound recording. As described above, the score may be a real-valued score indicative of whether the sound recording includes the one or more sound events. The real-valued score may be a probability distribution.

The outputs 316a, 316b may be used by the sound event detection model 300 to produce a plurality of binary classifications for a sound recording as output 318a, 318b. For example, by comparing the outputs 316a, 316b to respective thresholds, the sound event detection model 300 may generate a plurality of binary values representative of a positive or negative (e.g., yes or no, 0 or 1, 1 or 0, etc.) determination of the presence of each of the one or more sound events in the sound recording. Additionally or alternatively, the plurality of binary classifications may include one or more binary classifications for each timestep of the recording.

In some implementations, the outputs 316a, 316b may be used by the sound event detection model 300 to produce a binary classification indicative of if one or more or more sound events are present in the sound recording. By way of example, if the sound event detection model 300 is configured to detect a user's dog barking at a first neural network 304a and any electronic beep at a second neural network 304b, the sound event detection model may be configured to output a positive binary value if the outputs 316a, 316b indicate that both sound events (here, the user's dog barking and an electronic beep) are present in the sound recording.

In this regard, the sound event detection model 300 may be used similarly to the example method 200, but rather than being used to identify a single sound events or class of sounds are present, the sound event detection model 300 may be used to determine whether a plurality of different sound events or classes of sound are present in a sound recording.

### Training Sound Event Detection Models

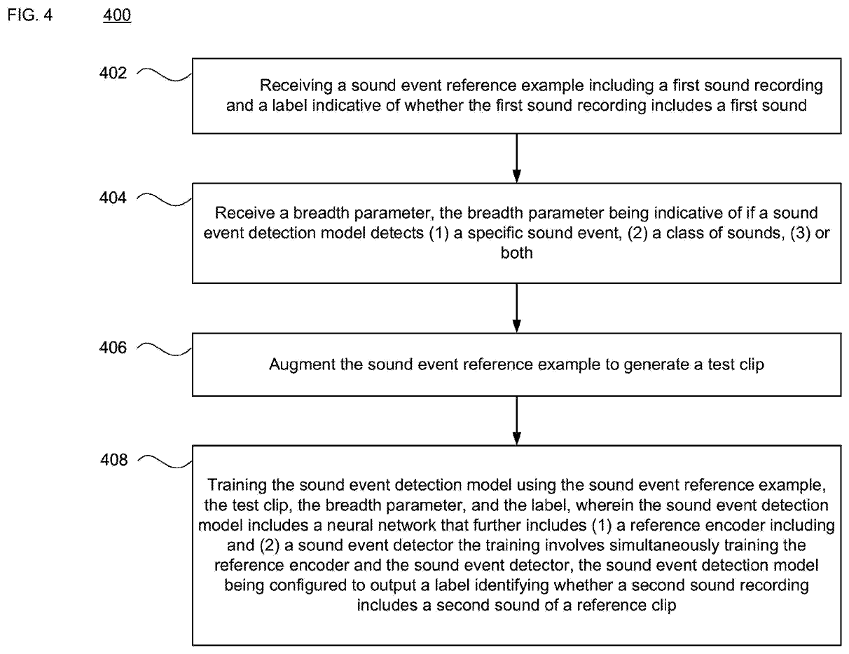

FIG. 4 illustrates an example method 400 of training a sound event detection model to determine whether one or more sound events are present in an environment of a user utilizing a sound event detection model 100, 300. The one or more sound events may be a specific sound event to be detected or a sound event from a class of sounds to be detected. As shown in block 402, a sound event reference example including a first sound recording and a label indicative of whether the first sound recording includes a first sound is received. The sound event detection model may include one or more training phases, in which the one or more neural networks 104, 304a, 304b including both the reference encoder 106, 306a, 306b and the sound event detector 108, 308a, 308b may be trained simultaneously. During the one or more training phases, the sound event detection model 100, 300 may receive or generate a plurality of training examples as the one or more inputs 102, 302 and the output 118 (e.g., a label).

In one instance, the plurality of training examples may be received as a triple. For example, each training example may contain a sound event reference example, a test clip, and a label indicative of if the sound event reference example is present in the test clip (e.g., a binary indicator). In such an example, the triple contains three elements, Thus, the sound event reference example may include or be a known recorded example of a targeted sound event or class of sounds on which the sound event detection model 100, 300 is to be trained. In this regard, the sound event reference example may correspond to the reference clip described above.

During the training phase, the test clip may function as the sound recording in the examples of FIGS. 1-3. In some implementations, the test clip and/or sound event reference example may be supplied by a user (e.g., the user's microwave beeping, the user's dog barking, etc.). In this regard, the sound event detection model may be trained to detect sounds of the user (e.g., the user's microwave beeping, the user's dog barking, etc.). Additionally or alternatively, the test clip and/or the sound event reference example may be supplied from a sound database such as the AudioSet database published by GOOGLE. In such an example, the user or database-supplied sound event reference example may include a label indicative of one or more sound events contained therein.

For example, if a label indicates that a sound event reference example includes a specific sound event or a sound event from a class of sounds, this may be a positive example of that specific sound event or a sound event from a class of sounds. Similarly, if a label indicates that a sound event reference example does not include a specific sound event or a sound event from a class of sounds, this may be a negative example of that specific sound event or a sound event from a class of sounds,

In some instances, positive and negative examples may be selected for targeted sound events or classes of sounds or rather specific sounds on which the sound event detection model is to be trained to detect. For a targeted sound event, positive examples may include reference examples of that targeted sound event. For example, if the targeted sound event is a microwave beep, the sound event reference examples may include microwave beeps. In some instances, if the microwave beep is a specific microwave beep of a particular user, the targeted sound reference examples may include one or more recordings of the user's microwave beep. In another example, if the targeted sound event is a user's dog barking, the sound event reference examples may include one or more recordings of the user's dog barking.

Negative examples for a targeted sound event may include reference events from the same class of sounds and other reference events that differ from the positive examples of the targeted sound event. For example, if the target sound event is a microwave beep, the negative examples may include other electronic beeps of kitchen appliances such as microwave beeps, oven beeps, air fryer beeps, etc. or any other sound not contained in the electronic beeps of kitchen appliances class.

For a targeted sound event from a class of sounds, positive examples may include various sound event reference examples from that class of sounds. For example, if the targeted sound class is electronic beeps of kitchen appliances, the sound event reference examples may include microwave beeps, oven beeps, air fryer beeps, etc. Similarly, negative examples may be sound event reference examples that do not match the targeted class of sounds. Negative examples for a targeted sound of a class of sounds may include various sound event reference examples from outside of that sound class. For example, if the targeted sound class is electronic beeps of kitchen appliances (microwave beeps, oven beeps, air fryer beeps, etc.) the sound event reference examples may include any sound or sounds not contained therein.

In another instance, the plurality of training examples may be received as the one or more inputs 102 as a tuple. In such an instance, each training example may optionally include a breadth parameter such as the breadth parameters described above. For example, each training example may contain a sound event reference example, a test clip, a label indicative of if the sound event reference example is present in the test clip (e.g., a binary indicator), and a breadth parameter, In this example, the tuple may contain four elements.

For instance, as shown in block 404, a breadth parameter is received by one or more processors. This breadth parameter is indicative of if the sound event detection model detects (1) a specific sound event of the one or more sound events, (2) a class of sounds of the one or more sound events, (3) or both. In one example, a breadth parameter may be included in the input 110, 310a, 310b input into the reference encoder 106, 306a, 306b and may indicate a specific sound event is to be detected. Again, this may be an example of narrow breadth, meaning the positive examples used may include test clips that match the target specific sound event included in the sound event reference example for that negative example, and the negative examples used may include sound events of the same class or any other sound that does not match the target specific sound event included in the sound event reference example for that negative example. By way of example, this could be used to differentiate the beeping of the user's microwave versus beeping from other microwaves. Or to differentiate the sound of a knock on the user's door from the knock on a different door.

In another example, the breath parameter may be included in the input 110, 310a, 310b input into the reference encoder 106, 306a, 306b and may indicate a class of sounds is to be detected. Again, this may be an example of wide breadth, meaning the positive examples used may include sound event reference examples contained within the same sound class (e.g., beeping from appliances) and the negative examples used may include any sound events outside of the class of sounds

At block 406, the sound event reference example is augmented to generate a test clip. For instance, sound event reference examples (negative and positive) may also be augmented by, for example, adding additional background noise to the sound event reference example, changing the volume of a sound within the sound event reference example, adding reverberation to the sound event reference example, and any combination thereof. By way of example, if a positive example for sound event reference example includes a microwave beep, the augmented sound event reference example or resulting test clip may include a microwave beep with additional background noise including any sound or sounds that does not match the sound event reference example, here the microwave beep and at differing volumes. In another example, if a positive example for a sound event reference example includes a user's dog barking, the augmented sound event reference example or resulting test clip may include the user's dog barking with background noise, at differing volumes, and with differing variations of the dog's bark. In other examples, the augmentation may include adding background noise to a sound event reference example, changing the volume of the sound event reference example, adding reverberation to the sound event reference example, and any combination thereof. Additionally or alternatively, negative examples for a targeted sound event may also be augmented in order to generate test clips including negative examples for the targeted sound event. In some examples, the positive and/or negative examples for a targeted sound class may also be augmented in order to generate test clips.

As shown at block 408, the sound event detection model is trained using the sound event reference example, the test clip, the breadth parameter, and the label. The sound event detection model includes a neural network that further includes a reference encoder. The sound event detection model also includes a sound event detector. The training involves simultaneously training the reference encoder and the sound event detector. The sound event detection model is configured to output a label identifying whether a second sound recording includes a second sound of a reference clip.

As noted above, the plurality of training examples, may be received by the sound event detection model 100, 300 the as one or more inputs 102, 302 in order to train the sound event detection model 100, 300. Each test clip, sound event reference example, and the breadth parameter may thus be used as training inputs to train the sound event detection model 100, 300. In addition, the labels indicative of whether the sound event reference example is present in the sound event reference example of the plurality of training examples during the training phase as training outputs. The training may involve using the training inputs and outputs to tune parameter values of the various neural networks of the sound event detection model 100, 300. In one example, the training may involve stochastic gradient descent optimization or other suitable training methodologies.

### Feature-Wise Linear Modulation Approach

In some instances, the sound event detection model 100, 300 may employ feature-wise linear modulation (FiLM) of a neural network (e.g., a convolutional neural network (CNN)). In some implementations, the reference encoder 106, 306a, 306b may use FILM conditioning to condition an activation function output by the reference encoder and input into the sound event detector 108, 308a, 308b.

FiLM conditioning includes applying a feature-wise affine transformation based on one or more inputs. In one implementation of the sound event detection model 100, 300, an input used as the basis for the feature-wise affine transformation may be inputs 110, 310a, 310b. Inputs 110, 310a, 310b may include one or more sound event reference examples as described above. The one or more inputs may be applied to a vector function or FiLM generator function or transformation function. The FiLM generator function may then be applied to the activation function of the neural network, creating a modified activation function or FiLM function. In the sound event detection model 100, 300 the reference encoder 106, 306a, 306b may use FiLM conditioning to modify the activation function and output the activation function, which may be used as an input 114, 314a, 314b for the sound event detector 108, 308a, 308b.

In one example the FiLM vector function, (γ, β), contains functions f and h, where f and h are functions of the one or more inputs, which outputs the vector as follows:

$${γ}_{i , \text{?}} = {f}_{\text{?}} ( {x}_{i} ) {β}_{i , \text{?}} = {h}_{\text{?}} ( {x}_{i} ) ,$$

$$\text{?} \text{indicates text missing or illegible when filed}$$

where xᵢ is an i^{th} input of the one or more inputs 110, 310a, 310b and f_{c} and h_{c} are representative of the c^{th} feature of the neural network. The FiLM vector function may be a function of an encoding of a sound event reference example, where the encoding may be a fixed dimensional embedding of the sound event reference example. The FiLM function may be obtained via the following transformation of the activation function F_{i,c}:

$$FiLM ( {F}_{i , \text{?}} \vert {γ}_{i , \text{?}} , {β}_{i , \text{?}} ) = {γ}_{i , \text{?}} {F}_{i , \text{?}} + {β}_{i , \text{?}}$$

$$\text{?} \text{indicates text missing or illegible when filed}$$

The above modulation may scale features within activation function based on the FiLM vector function, (γ, β) which may be derived from the one or more inputs 110, 310a, 310b. A separate FiLM function may be learned for each layer of the reference encoder 106, 306a, 306b resulting in one or more FiLM layers (i.e., conditioned layers), After an activation function is conditioned based on a sound event reference example, the conditioned activation function may be further conditioned based on subsequent sound event reference examples.

The conditioned activation function may be output from the reference encoder 106, 306a, 306b and received as an input 114, 314a, 314b by the sound event detector 108, 308a, 308b and utilized in determining whether a sound recording includes one or more sound events, such as a specific sound event or class of sounds.

In some instances, the sound event detector 108, 308a, 308b may utilize FiLM conditioning in determining whether a sound recording includes one or more sound events, such as a specific sound event or class of sounds. In this regard, the one or more conditioned layers of the activation function may be further modified or conditioned in the sound event detector 108, 308a, 308b where inputs 112, 312a, 312b may be the inputs of functions f and h, contained by the FiLM vector function. In this regard, the sound event detector 108, 308a, 308b may use the further conditioned activation function in determining whether a sound recording includes one or more sound events, such as a specific sound event or class of sounds.

### General Transformer Approach

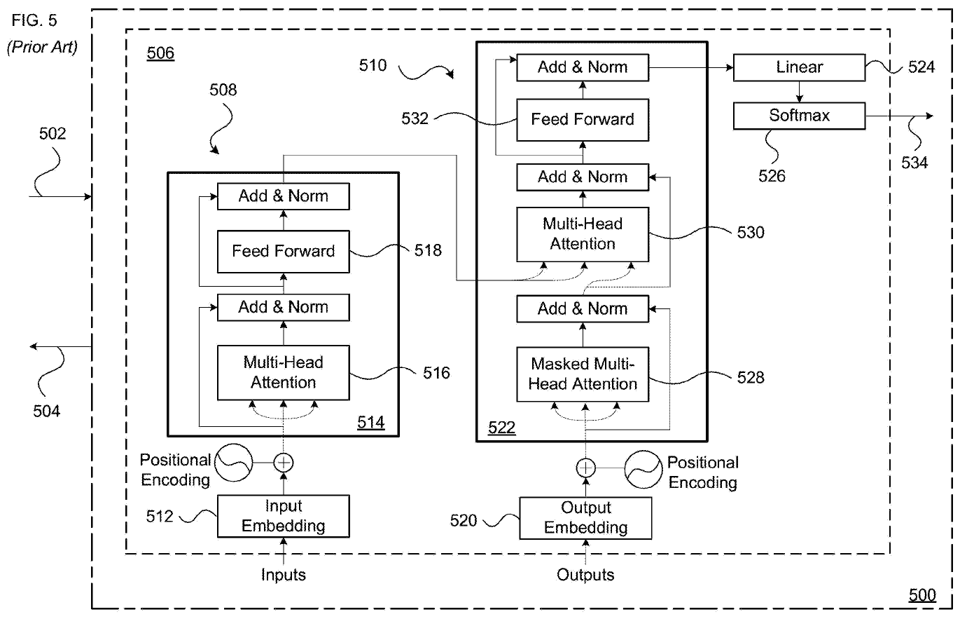

In some instances, the sound event detection model 100, 300 may employ a self-attention architecture, such as a transformer neural network encoder-decoder architecture. An example of a general Transformer neural network architecture is depicted in FIG. 5, and which is further described in U.S. Pat. No. 10,452,978, entitled “Attention-based sequence transduction neural networks”, the entire disclosure of which is incorporated herein by reference. In this example, each of the reference encoders 106, 306a, 306b may correspond to the encoder neural network 508 and each of the sound event detector 108, 308a, 308b correspond to the decoder neural network 510. While a Transformer neural network architecture may be employed, the approach described herein can also be utilized with different architectures such as, for example, decoder-only Transformer configurations or encoder-only Transformer configurations.

System 500 of FIG. 5 may be implemented as computer programs by processors of one or more computers in one or more locations as discussed further below. The system 500 may receive an input sequence 502 and process the input sequence 502 to transduce the input sequence 502 into an output sequence 504. The input sequence 502 may have a respective network input at each of multiple input positions in an input order, and the output sequence 504 may have a respective network output at each of multiple output positions in an output order.

System 500 can perform any of a variety of tasks that require processing sequential inputs to generate sequential outputs. System 500 includes an attention-based sequence transduction neural network 506, which in turn includes an encoder neural network 508 and a decoder neural network 510. The encoder neural network 508 may be configured to receive the input sequence 502 and generate a respective encoded representation of each of the network inputs in the input sequence. An encoded representation may be a vector or other ordered collection of numeric values. The encoder neural network 508 may function as one of the reference encoders 106, 306a, 306b described above.

The decoder neural network 510 may function as one of the sound event detectors 108, 308a, 308b described above. The decoder neural network 510 may be configured to use the encoded representations of the network inputs to generate the output sequence 504. Generally, both the encoder neural network 508 and the decoder neural network 510 are attention-based. In some cases, neither the encoder nor the decoder includes any convolutional layers or any recurrent layers. The encoder neural network 508 includes an embedding layer (input embedding) 512 and a sequence of one or more encoder subnetworks 514. The encoder neural network 508 network may include N encoder subnetworks 514.

The embedding layer 512 may be configured, for each network input in the input sequence, to map the network input to a numeric representation of the network input in an embedding space, e.g., into a vector in the embedding space. The embedding layer 512 then provides the numeric representations of the network inputs to the first subnetwork in the sequence of encoder subnetworks 514. The embedding layer 512 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 506. In other cases, the positional embeddings may be fixed and are different for each position.

The combined embedded representation may then be used as the numeric representation of the network input. Each of the encoder subnetworks 514 may be configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input may be the numeric representations generated by the embedding layer 512, and, for each encoder subnetwork other than the first encoder subnetwork in the sequence, the encoder subnetwork input may be the encoder subnetwork output of the preceding encoder subnetwork in the sequence.

Each encoder subnetwork 514 includes an encoder self-attention sub-layer 516. The encoder self-attention sub-layer 516 may be configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism may be a multi-head attention mechanism as shown. In some implementations, each of the encoder subnetworks 514 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 5.

Some or all of the encoder subnetworks can also include a position-wise feed-forward layer 518 that may be configured to operate on each position in the input sequence separately. In particular, for each input position, the position-wise feed-forward layer 518 may be configured to receive an input at the input position and apply a sequence of transformations to the input at the input position to generate an output for the input position. The inputs received by the position-wise feed-forward layer 518 can be the outputs of the layer normalization layer when the residual and layer normalization layers are included or the outputs of the encoder self-attention sub-layer 516 when the residual and layer normalization layers are not included. The transformations applied by the position-wise feed-forward layer 518 will generally be the same for each input position (but different feed-forward layers in different subnetworks may apply different transformations).

In cases where an encoder subnetwork 514 includes a position-wise feed-forward layer 518 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 514.

Once the encoder neural network 508 has generated the encoded representations, the decoder neural network 510 may be configured to generate the output sequence in an auto-regressive manner. That is, the decoder neural network 510 may generate the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 510 may be auto-regressive, at each generation time step, the decoder neural network 510 operates on the network outputs that have already been generated before the generation time step, i.e., the network outputs at output positions preceding the corresponding output position in the output order. In some implementations, to ensure this is the case during both inference and training, at each generation time step the decoder neural network 510 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder neural network 510 operate on data at output positions preceding the given output positions (and not on data at any other output positions), it will be understood that this type of conditioning can be effectively implemented using shifting.

The decoder neural network 510 includes an embedding layer (output embedding) 520, a sequence of decoder subnetworks 522, a linear layer 524, and a softmax layer 526. In particular, the decoder neural network can include N decoder subnetworks 522. However, while the example of FIG. 5 shows the encoder neural network 508 and the decoder neural network 510 including the same number of subnetworks, in some cases the encoder neural network 508 and the decoder neural network 510 include different numbers of subnetworks. The embedding layer 520 may be configured to, at each generation time step, for each network output at an output position that precedes the current output position in the output order, map the network output to a numeric representation of the network output in the embedding space. The embedding layer 520 then provides the numeric representations of the network outputs to the decoder subnetwork 522 in the sequence of decoder subnetworks.

In some implementations, the embedding layer 520 may be configured to map each network output to an embedded representation of the network output and combine the embedded representation of the network output with a positional embedding of the output position of the network output in the output order to generate a combined embedded representation of the network output. The combined embedded representation may be then used as the numeric representation of the network output. The embedding layer 520 generates the combined embedded representation in the same manner as described above with reference to the embedding layer 512.

Each decoder subnetwork 522 may be configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 522 includes two different attention sub-layers: a decoder self-attention sub-layer 528 and an encoder-decoder attention sub-layer 530. Each decoder self-attention sub-layer 528 may be configured to, at each generation time step, receive an input for each output position preceding the corresponding output position and, for each of the particular output positions, apply an attention mechanism over the inputs at the output positions preceding the corresponding position using one or more queries derived from the input at the particular output position to generate an updated representation for the particular output position. That is, the decoder self-attention sub-layer 528 applies an attention mechanism that may be masked so that it does not attend over or otherwise process any data that may not be at a position preceding the current output position in the output sequence.

Each encoder-decoder attention sub-layer 530, may be configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 530 applies attention over encoded representations while the decoder self-attention sub-layer 528 applies attention over inputs at output positions.

In the example of FIG. 5, the decoder self-attention sub-layer 528 is shown as being before the encoder-decoder attention sub-layer in the processing order within the decoder subnetwork 522. In other examples, however, the decoder self-attention sub-layer 528 may be after the encoder-decoder attention sub-layer 530 in the processing order within the decoder subnetwork 522 or different subnetworks may have different processing orders. In some implementations, each decoder subnetwork 522 includes, after the decoder self-attention sub-layer 528, after the encoder-decoder attention sub-layer 530, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 522 also include a position-wise feed-forward layer 532 that may be configured to operate in a similar manner as the position-wise feed-forward layer 518 from the encoder neural network 508. In particular, the position-wise feed-forward layer 532 may be configured to, at each generation time step: for each output position preceding the corresponding output position: receive an input at the output position and apply a sequence of transformations to the input at the output position to generate an output for the output position. The inputs received by the position-wise feed-forward layer 532 can be the outputs of the layer normalization layer (following the last attention sub-layer in the decoder subnetwork 522) when the residual and layer normalization layers are included or the outputs of the last attention sub-layer in the decoder subnetwork 522 when the residual and layer normalization layers are not included. In cases where a decoder subnetwork 522 includes a position-wise feed-forward layer 532, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation, The outputs of this layer normalization layer can then be used as the outputs of the decoder subnetwork 522.

At each generation time step, the linear layer 524 may apply a learned linear transformation to the output of the last decoder subnetwork 522 in order to project the output of the last decoder subnetwork 522 into the appropriate space for processing by the softmax layer 526. The softmax layer 526 then applies a softmax function over the outputs of the linear layer 524 to generate the probability distribution (output probabilities) 534 over the possible network outputs at the generation time step. The decoder neural network 510 can then select a network output from the possible network outputs using the probability distribution.

At each generation time step, the linear layer 524 may apply a learned linear transformation to the output of the last decoder subnetwork 522 in order to project the output of the last decoder subnetwork 522 into the appropriate space for processing by the softmax layer 526. The softmax layer 526 then applies a softmax function over the outputs of the linear layer 524 to generate the probability distribution (output probabilities) 534 over the possible network outputs at the generation time step. The decoder neural network 510 can then select a network output from the possible network outputs using the probability distribution.

### Example Computing Architecture

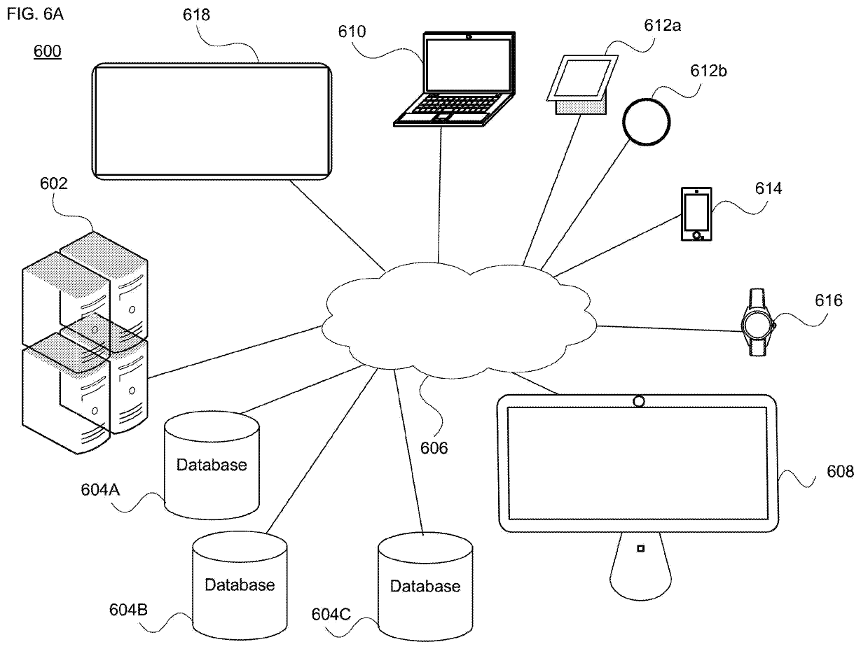

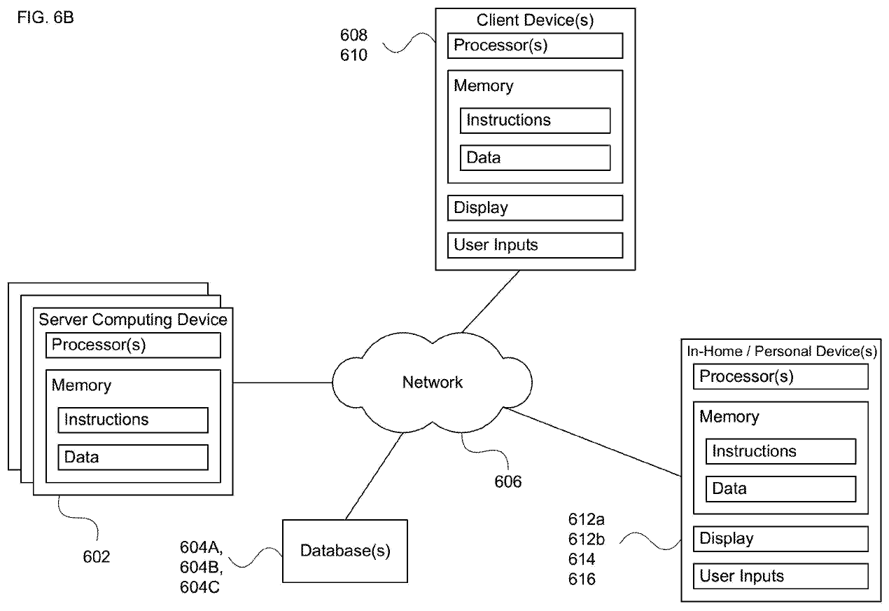

The sound event detection model 100, 300 discussed herein may be trained on one or more tensor processing units (TPUs), CPUs or other computing architectures in order to generate outputs 118, 318 as discussed above. One example computing architecture to support this is shown in FIGS. 6A and 6B. In particular, FIGS. 6A and 6B are pictorial and functional diagrams, respectively, of an example system 600 that includes a plurality of computing devices and databases connected via a network. For instance, the computing device 602 may be a cloud-based server system.

In one example, the computing devices 602 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 602 may include one or more server computing devices that are capable of communicating with any of the computing devices 608-618 via the network 606.

Databases 604A, 604B, and 604C may store one or more sound event reference examples, outputs (e.g., real-valued score such as a probability distribution, binary classifier), and/or sound event detection modules, respectively. The server system may access the databases via network 606.

Client devices may include one or more of a desktop-type integrated client computer 608, a laptop or tablet PC 610 and in-home devices such as smart display 612a and/or a smart home device 612b. Other client devices may include a personal communication device such as a mobile phone or PDA 614 or a wearable device 616 such as a smartwatch or head-mounted display (e.g., a virtual reality headset), etc. Another example client device is a large screen display such as a high-definition wall-mountable television 618, such as might be used in a living room or den during family gatherings.

As shown in FIG. 6B, each of the server computing devices 602 and computing devices 608-618 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media, The instructions may be any set of instructions to be executed directly (such as machine code) or indirectly (such as scripts) by the processor(s). For example, the instructions may be stored as computing device code on the computing device-readable medium. In that regard, the terms “instructions”. “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 6B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of the server computing devices 602. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices that is operable to display information (e.g., text, imagery and/or other graphical elements). Other output devices, such as speaker(s) may also provide information to users.

The user-related computing devices (e.g., 608-618) may communicate with a back-end computing system (e.g., server computing devices 602) via one or more networks, such as network 606. The user-related computing devices may also communicate with one another without also communicating with a back-end computing system. The network 606, and intervening nodes, may include various configurations such as a local in-home network, and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces,

In one example, computing device 602 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 602 may include one or more server computing devices that are capable of communicating with any of the devices via the network 606. Module information or other data derived from the sound event detection modules may be shared by the server with one or more of the client computing devices. Alternatively or additionally, the client device(s) may maintain their own databases, modules, etc.

The features and methodology described herein may provide a model configured to perform personalized sound sensing in complex sound environments. The architecture allows for detection of sound events in environments with increased intrinsic and extrinsic variability. Moreover, detection may be accomplished without isolating a target sound event. Aspects of the technology employ a single model that is able to handle both instance-level and class-level event detection and who's targeted behavior (e.g., what the instance or class is) is controllable by the user via the breadth parameter and one or more reference example(s). This control is particularly beneficial because in a personalized setting, the target and/or the background sound(s) to be ignored are variable. Furthermore, the architecture described herein may be utilized in both resource constrained and less-resource constrained systems. For example, a Transformer neural network architecture as described herein may be particularly advantageous in a less-resource constrained system (e.g., system with less-limited processing power); whereas a Feature-wise Linear Modulation (FiLM) conditioning approach described herein may be particularly advantageous in a resource constrained system (e.g., systems with limited processing power).

Although the technology herein has been described with reference to particular implementations, it is to be understood that these implementations are merely illustrative of the principles and applications of the present technology. It is therefore to be understood that numerous implementations may be made to the illustrative implementations and that other arrangements may be devised without departing from the spirit and scope of the present technology as defined by the appended claims.

1. A computer-implemented method comprising:
receiving, by one or more processors, a sound event reference example including a first sound recording and a label indicative of whether the first sound recording includes a first sound;
receiving, by the one or more processors, a breadth parameter, the breadth parameter being indicative of whether a sound event detection model detects (1) a specific sound event, (2) a class of sounds, (3) or both;
augmenting, by the one or more processors, the sound event reference example to generate a test clip; and
training, by the one or more processors, the sound event detection model using the sound event reference example, the test clip, the breadth parameter, and the label, wherein the sound event detection model includes a neural network;
wherein the neural network includes (1) a reference encoder and (2) a sound event detector, in which the training involves simultaneously training the reference encoder and the sound event detector, the sound event detection model being configured to output a label identifying whether a second sound recording includes a second sound of a reference clip.

2. The method of claim 1, further comprising:
receiving the second sound recording, the second sound recording containing a sampling of sounds from an environment of a user; and
determining whether the second sound recording includes the sound of the reference clip using the trained sound event detection model.

3. The method of claim 2, wherein determining whether the second sound of the reference clip is present in the second sound recording using the trained sound event detection model includes:
determining a probability distribution indicative of whether (1) a specific sound event, (2) a class of sounds, (3) or both are present in the second sound recording; and
outputting a binary classifier indicative of whether (1) a specific sound event, (2) a class of sounds, (3) or both are present in the second sound recording based on the probability distribution.

4. The method of claim 1, wherein the neural network employs feature-wise linear modulation (FiLM).

5. The method of claim 1, wherein the neural network is a convolutional neural network (CNN).

6. The method of claim 1, wherein the neural network employs a Transformer neural network architecture.

7. The method of claim 1 wherein, augmenting the sound event reference example includes adding background noise to the sound event reference example.

8. The method of claim 1, wherein augmenting the sound event reference example includes changing a volume of the sound event reference example.

9. The method of claim 1, wherein augmenting the sound event reference example includes adding reverberation to the sound event reference example.

10. The method of claim 1, wherein the first sound recording and the second sound recording are from an environment of a user.

11. A computer-implemented method comprising:
receiving, by one or more processors, a first sound recording, the first sound recording containing a sampling of sounds from an environment of a user;
receiving, by the one or more processors, a breadth parameter, the breadth parameter being indicative of whether a sound event detection model detects (1) a specific sound event, (2) a class of sounds, (3) or both, wherein the sound event detection model includes a first neural network having a first reference encoder and a first sound event detector; and
determining, by the one or more processors, whether the first sound recording includes a sound of a reference clip using a sound event detection model by determining a probability distribution indicative of whether (1) a specific sound event, (2) a class of sounds, (3) or both are present in the first sound recording, the sound event detection model being configured to output a label identifying whether the first sound recording includes the sound of the reference clip.

12. The method of claim 11, wherein determining whether the sound of the reference clip is present in the first sound recording using the sound event detection model further includes: outputting a binary classifier indicative of whether (1) a specific sound event, (2) a class of sounds, (3) or both are present in the first sound recording based on the probability distribution.

13. The method of claim 11, wherein the first sound recording, the breadth parameter, and the reference clip are input into the first neural network.

14. The method of claim 13, wherein determining whether the sound of the reference clip is present in the first sound recording includes inputting the reference clip and the breadth parameter into the first reference encoder in order to generate one or more conditioning elements.

15. The method of claim 14, wherein the one or more conditioning elements includes at least one of (1) a conditioned activation function based on the reference clip and (2) an encoding of the reference clip.

16. The method of claim 14, wherein determining whether the sound of the reference clip is present in the first sound recording includes inputting the one or more conditioning elements into the first sound event detector in order to determine the probability distribution.

17. The method of claim 11, wherein:
the first neural network employs feature-wise linear modulation (FiLM); and
wherein the first neural network is a convolutional neural network (CNN).

18. The method of claim 11, wherein the first neural network employs a Transformer neural network architecture.

19. The method of claim 11, wherein the reference clip includes a sampling of sounds from the environment of the user.

20. The method of claim 11, further comprising:
receiving a second sound recording, the second sound recording containing a sampling of sounds from the environment of the user; and
determining a second sound of a second reference clip is present in the second sound recording using the sound event detection model, the sound event detection model being configured to output a label identifying whether a second sound of a second reference clip is present in the second sound recording;
wherein the sound event detection model includes a second neural network that further includes a second reference encoder and a second sound event detector.
